(19) United States
(12) Patent Application Publication
(10) Pub. No.: US 2002/0025878 A1
(43) Pub. Date: Feb. 28, 2002

(54) Helical gear type limited slip differential

(76) Inventor: Jeong-Heon Kam, Kunpo-City (KR)

Correspondence Address: BIRCH STEWART KOLASCH & BIRCH, PO BOX 747, FALLS CHURCH, VA, 22040-0747, US

(21) Appl. No.: 09/834,931

(22) Filed: Apr. 16, 2001

(30) Foreign Application Priority Data
Aug. 30, 2000 (KR) 2000-50792

(51) Int. Cl. F16H 48/10

(52) U.S. Cl. 475/249; 475/252

(57) ABSTRACT

A helical gear type limited slip differential (LSD), the LSD comprising a differential gear case integrally connected to a ring gear rotated by power output from a transmission, a side gear splined to drive shafts inserted into both sides of the differential gear case to transmit power to the drive shafts, and a plurality of pinion gears meshed to external sides of the side gear via helical gear for maintaining a parallel position with the drive shafts, wherein each pinion gear is unsymmetrically arranged within the differential gear case, such that only pinion gears mounted within the differential gear case are structurally changed in arrangement thereof to improve torque bias ratio for determining a differential limiting function without altering the overall structural elements, thereby enabling to apply same even to off-road vehicles.

### BACKGROUND OF THE INVENTION

b 1. Field of the Invention

The present invention relates to a differential limiting device for temporarily stopping operation of differential device for enabling a vehicle to turn for normal driving, and more particularly to helical gear type limited slip differential adapted to use frictional force generated from helical type pinion gear to thereby limit differential operation.

2. Description of the Prior Art

In general, a vehicle uses a clutch and a transmission for properly transmitting power generated from an engine to wheels and a differential device is used for appropriately distribute power derived from the transmission to wheels. The differential device is connected to a transmission where output from a transmission is directly transmitted to a differential device in a front wheel drive vehicle while output from a transmission is transmitted to a differential device through a driving shaft at a rear wheel drive vehicle.

The differential device thus described serves to generate a speed difference between inner and outer wheels while a vehicle is turned to enable a smooth change of directions and an obtainment of safe driving on a rugged road surface as well.

In other words, when a vehicle is turned, outer wheels are made to produce more rotation than that of inner wheels to enable the vehicle to turn. The differential device is therefore an essential device for safely turning a vehicle.

However, in a vehicle equipped with a differential device, when there occurs a big difference in friction on road surface contacted by both drive wheels, a power transmission is generated between both drive wheels. As a result, one drive wheel having less frictional force runs idle while wheel having a larger frictional force is stopped to render the vehicle to be difficult in driving. In other words, when one drive wheel is ditched, only the drive wheel in the ditch is rotated while the other drive wheel is not rotated, causing the vehicle to be in an awkward situation where the vehicle cannot be pulled out of the ditch by its own strength.

In an effort to solve the aforementioned problem, a limited slip differential (hereinafter referred to simply as LSD) is adopted to off-road vehicles which run on rugged roads, and almost all the vehicles are equipped with LSD of late. The LSD comes in various kinds according to shape and structure. The present invention relates to a helical gear type LSD among a variety of LSDs.

FIGS. 1, 2 and 3 are schematic drawings of helical gear type LSD, where the LSD includes a differential gear case 51 integrally connected to a ring gear rotated by power output from a transmission, drive shafts 52 inserted into both sides of the differential gear case 51, a side gear 53 splined to the drive shaft 52, a plurality of pinion gears 55 meshed to external side of the side gear 53 via helical gear and mounted at a plurality of gear grooves 54 provided at an inner side of the differential gear case 51 for maintaining a parallel position with the drive shaft 52, two restraining plates 56 mounted within the differential gear case 51 for restraining a predetermined size of space by blocking sides of the plurality of pinion gears 55, and two side caps 57 mounted outside of the differential gear case 51.

The helical gear type LSD thus constructed acts to perform a differential operation according to resistance applied to both wheels and uses frictional force applied between the pinion gear and the differential gear case to restrain the differential operation.

In case resistance transmitted through the drive shafts 52 from both wheels is equal, the differential gear case 51 and the side gear 53 are integrally rotated. Both drive shafts 55 splined to the slide gear 53 are rotated at the same speed to allow a vehicle to stably drive back and forth.

If a vehicle is turned, the inner wheels are applied with a larger resistance than that of the outer wheels, thereby causing the pinion gear 55 inside the differential gear case 51 to revolve and simultaneously rotate on its axis while power of the inner wheels is transmitted to the outer wheels and the outer wheels are made to rotate at a speed faster than that of the inner wheels. The function thus described is called differential operation where the pinion gear 55 is gyrated on its axis by resistance difference applied to both wheels whereby one wheel is rotated fasten than the differential gear case 51 while the other wheel is gyrated slower than the differential gear case 51.

At this time, the pinion gears 55 are further described in rotations thereof. It should be first noted that thrust force in the axial direction is generated according to gyration of the pinion gears 55. In other words, the pinion gears 55 and the side gear 53 are mutually meshed via helical gear to generate thrust power in the axial direction parallel to rotative axle when the pinion gears 55 are rotated. The side gears 53 and pinion gears 55 are all restricted by the restraining plates 56 and the side caps 57 in movement toward axial direction, such that when the pinion gears 55 rotate on their axes, frictional force occurs among sectional surface of the side gears 53, sectional surfaces of the restraining plates 56 and pinion gears 55 and differential gear case 51. Furthermore, frictional force is also generated at the gear grooves 54 formed at the pinion gears 55 and the differential gear case 51. The frictional force is also generated at the helical gear. The frictional force thus generated restricts the differential operation, and the frictional force grows larger as revolution difference between both drive shafts 52 is increased to thereby prevent the differential operation from occurring.

In other words, as resistance difference applied to both wheels is enlarged, rotative speed of the pinion gears 55 is increased, whereby frictional force generated within the differential gear case 51 is increased.

When the frictional force inside the differential gear case is increased, the pinion gears are braked in rotation thereof to prevent excessive differential operation from occurring. As a result, the LSD uses frictional force generated within the differential gear case 51 to keep difference in rotation between the differential gear case 51 and the drive shafts 52 from exceeding beyond a predetermined scope, thereby preventing idling.

The helical gear type LSD thus described, being, simple in construction and of a quick response, is quite adequate to general passenger vehicles or sports vehicles and has an advantage in costs and weight compared with other methods. However there is a problem in that obtainment of maximum driving force is limited in view of system principle utilizing frictional force of helical gear, making it difficult to apply the helical gear type LSD to off-road vehicles requiring a differential limiting function of high performance.

### SUMMARY OF THE INVENTION

The present invention is disclosed to solve the aforementioned problems and it is an object of the present invention to provide a helical gear type limited slip differential adapted to improve torque bias ratio (TBR) for determining differential limiting function simply by changing structure arrangement of pinion gear mounted within a differential gear case, thereby enabling to adopt same to off-road vehicles.

In accordance with the object of the present invention, there is provided a helical gear type limited slip differential (LSD), the LSD comprising a differential gear case integrally connected to a ring gear rotated by power output from a transmission, a side gear splined to drive shafts inserted into both sides of the differential gear case to transmit power to the drive shafts, and a plurality of pinion gears meshed to external sides of the side gear via helical gear for maintaining a parallel position with the drive shafts, wherein each pinion gear is unsymmetrically arranged within the differential gear case.

### BRIEF DESCRIPTION OF THE DRAWINGS

For fuller understanding of the nature and objects of the invention, reference should be made to the following detailed description taken in conjunction with the accompanying drawings in which:

FIG. 1 is an exploded perspective view for illustrating a helical gear type limited slip differential according to the prior art;

FIG. 2 is a sectional view of a helical gear type limited slip differential;

FIG. 3 is a sectional view taken along line A-A of FIG. 2;

FIG. 4 is a sectional view for illustrating a helical gear type limited slip differential according to the prior art;

FIG. 5 is a schematic view where distribution of torque bias ratio is exemplified according to angle arrangement of pinion gear; and

FIG. 6 is a graphic drawing where change of torque bias ratio is illustrated according to angle arrangement of pinion gear.

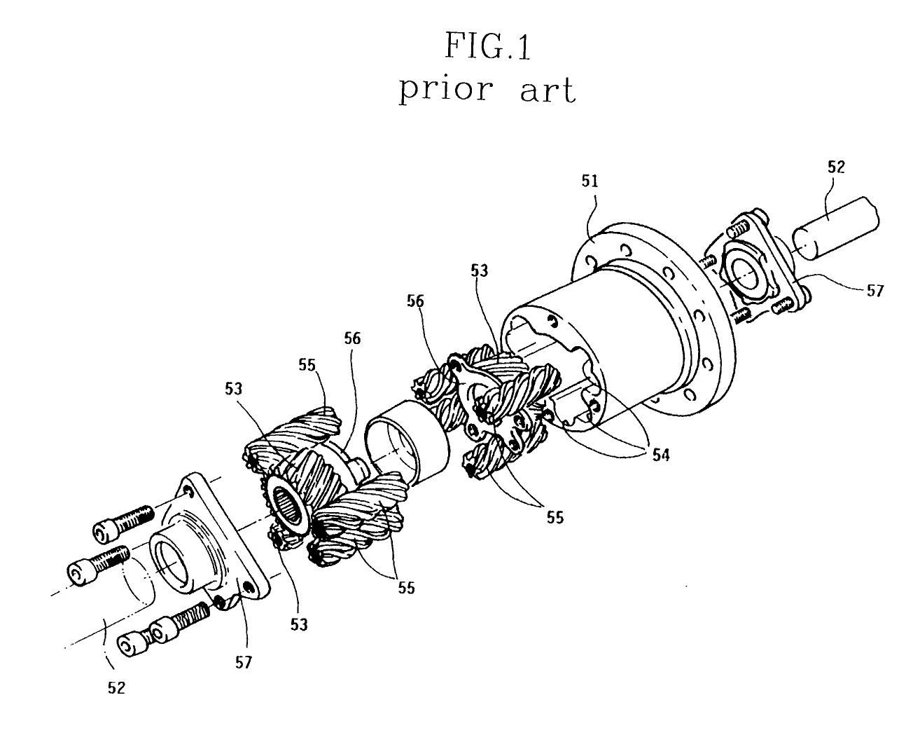

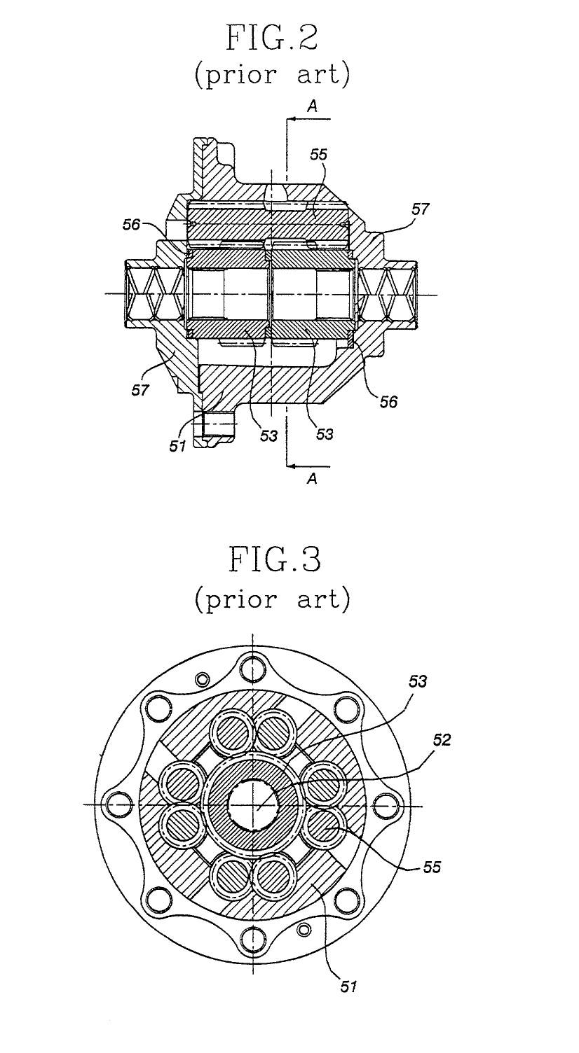

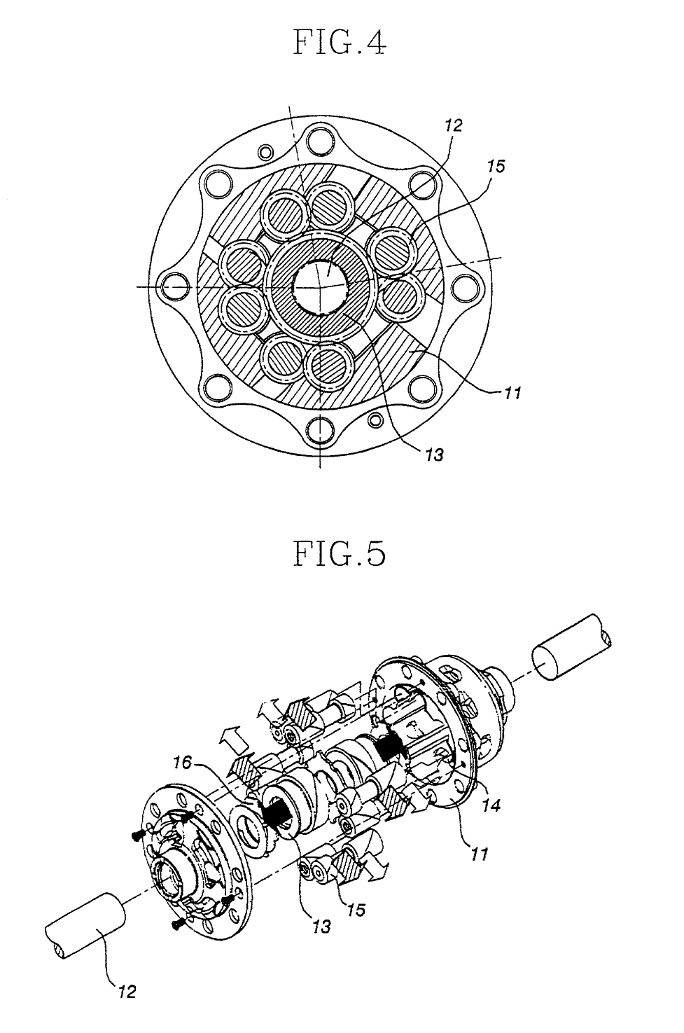

### DETAILED DESCRIPTION OF THE INVENTION

Now, preferred embodiment of the present invention will be described in detail with reference to the accompanying drawings.

A helical gear type limited slip differential according to the present invention includes, as illustrated in FIG. 5, a differential gear case 11 integrally connected to a ring gear rotated by power output from a transmission, a side gear 13 splined to drive shafts inserted into both sides of the differential gear case 11 to transmit power to the drive shafts 12, and a plurality of pinion gears 15 meshed to external sides of the side gear 13 via helical gear for maintaining a parallel position with the drive shafts 12.

At this time, the pinion gears 15 are arranged in pairs and arranged angle therebetween is 75 degrees. The pinion gears 15 are therefore unsymmetrically arranged inside the differential gear case 11. The angle arrangement at the pinion gears 15 may be varied according to needed performance but in order to realize an unsymmetry, the arranged angle should not be a 90-degree when the pinion gears are arranged in four pairs.

The helical gear type LSD thus described according to the present invention has the same function as that of the prior art but load toward radial direction relative to the side gear is increased to improve differential limiting performance due to unsymmetrical arrangement of the pinion gears.

In other words, the helical gear type LSD according to the present invention is basically comprised of same elements as those of the prior art and performs the same function, except that pinion gears are lop-sidedly mounted to one side to form an unsymmetry in comparison with pinion gears of the prior art which are symmetrically arranged.

As illustrated in the drawing, when the pinion gears 15 are formed in four pairs, each pair is divided by an interval of 75 degrees making a total angle of 225 degrees for the present invention in comparison with 90 degrees with a total angle of 270 degrees for the prior art.

Now, operational principle of differential limiting function directly related to the present invention will be described whereas basic operational principle of the differential limiting function will be omitted. Kinds of frictional torque for performing the differential limiting function in the LSD and principal elements for generating same will be described with reference to FIG. 5.

A first frictional torque between the pinion gears 15 and the differential gear case 11 is generated by gear reaction force according to pressing angle of the pinion gears 15. The first frictional torque therefore radially reacts relative to the drive shaft 12.

A second frictional torque, being an element according to shapes of the pinion gears 15 and side gear 13, is generated by friction between the side gear 13 and the restraining plate 16 and between sections of the pinion gears 15 and differential gear case 11 according to thrust power generated when the pinion gears 15 are rotated. The second frictional torque is therefore determined by angle of torsion according to helical shapes of the pinion gears 15 and side gear 13.

The aforementioned two torques were principal elements in determining a differential limiting capability of an LSD according to the prior art, such that pressing angle of pinion gears 15, angle of torsion and frictional coefficients of each frictional member have been changed to improve the differential limiting performance. However, high level of TBR performance could not be controlled due to basic structure and principle of helical gear type LSD.

In other words, if pressing angle and angle of torsion of the pinion gears 15 are high, performance of LSD can be increased but gear elements as desired in numerical terms cannot be altered owing to its own restriction of helical gear.

Accordingly, pairs of pinion gears distributed in symmetrical form are arranged in unsymmtrical form in the present invention to increase the frictional force between pinion gears 15 and gear grooves 14 of the differential gear case 11, thereby improving the differential limiting performance. At this time, frictional force thus generated acts in the radial direction just like the frictional force according to the pressing angle.

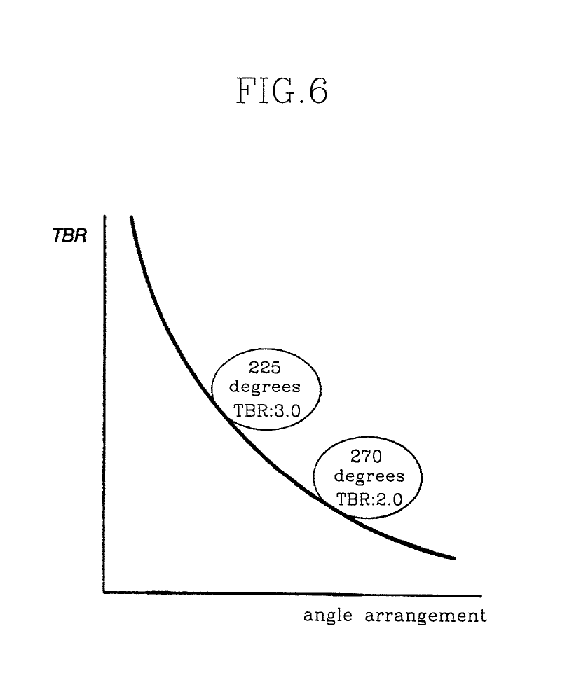

FIG. 6 is a graphic drawing for illustrating change of torque bias ratio according to changed angle arrangement of the pinion gears 15.

When pair of pinion gears is given as four pairs, the TBR was approximately 2.0 according to various operational elements of LSD in case of LSD according to the prior art where an overall angle was 270 degrees from a first pinion gear pair to least pinion gear pair, however, the LSD according to the present invention having an overall angle of 225 degrees is added by a differential limiting function given by eccentrical action of helical pinion gear pairs, thereby improving the TBR to about 3.0. At this time, differential limiting power by way of eccentricity can be increased to enable to develop an LSD of high TBR as arrangement angle among the pinion gear pairs is narrowed.

As apparent from the foregoing, there is an advantage in the helical gear type limited slip differential thus described according to the present invention in that only pinion gears mounted within a differential gear case are structurally changed in arrangement thereof to improve TBR for determining a differential limiting function without altering the overall structural elements, thereby enabling to apply same even to off-road vehicles.

What is claimed is:

1. A helical gear type limited slip differential (LSD), the LSD comprising a differential gear case integrally connected to a ring gear rotated by power output from a transmission, a side gear splined to drive shafts inserted into both sides of the differential gear case to transmit power to the drive shafts, and a plurality of pinion gears meshed to external sides of the side gear via helical gear for maintaining a parallel position with the drive shafts, wherein each pinion gear is unsymmetrically arranged within the differential gear case.

2. The LSD as defined in claim 1, wherein the pinion gears are arranged in pair and an angle between pinion gears is less than ninety degrees.

3. The LSD as defined in claim 2, wherein arranged angle of the pinion gears is seventy five degrees.
